(19) United States
(12) Patent Application Publication
(10) Pub. No.: US 2003/0048229 A1
(43) Pub. Date: Mar. 13, 2003

(54) Using satellite ephemeris data to dynamically position an earth station antenna

(76) Inventors: John Schmid, Gaithersburg, MD (US); Stan Kay, Rockville, MD (US); Russell Fang, Potomac, MD (US); Gregory Ernst, Gaithersburg, MD (US); Mark Steber, Frederick, MD (US); Kumud Patel, Germantown, MD (US); Jeffrey Singer, Gaithersburg, MD (US)

Correspondence Address: Hughes Electronics Corporation, Patent Docket Administration, Bldg. 1, Mail Stop A109, P.O. Box 956, El Segundo, CA, 90245-0956, US

(21) Appl. No.: 10/147,096

(22) Filed: May 16, 2002

Related U.S. Application Data
(60) Provisional application No. 60/318,288, filed on Sep. 10, 2001.

(51) Int. Cl. H01Q 3/00; H01Q 3/12

(52) U.S. Cl. 343/757; 343/761

(57) ABSTRACT

The present invention relates to a method and apparatus of using ephemeris data for positioning of an antenna of an earth station. Ephemeris data is transmitted from the satellite to the earth station, wherein the ephemeris data comprises positioning data of a satellite. The ephemeris data is received by the earth station and is used to realize the location of the satellite. The antenna of the earth station is adjusted to point toward the satellite, using the received ephemeris data.

### RELATED APPLICATIONS

This application claims priority to U.S. provisional application serial number 60/318,288, which is incorporated in its entirety herein by reference.

### FIELD OF INVENTION

This invention relates generally to the field of dynamically positioning an earth station antenna, and more particularly, a method of using satellite ephemeris data to dynamically position an earth station antenna.

### BACKGROUND OF THE INVENTION

Earth stations receive information transmitted from satellites in orbit. An earth station antenna on the surface of the earth serves as a receiver of information from the satellite. A user of the information can expect to receive the requested information via the earth station antenna. For example, the information may be provided to the user by way of a cable provided between the earth station and the user.

Earth station antennas may shift from their satellite pointing locations over time due to weather conditions and mechanical errors, for example. Therefore, earth station antennas are periodically re-calibrated to insure that they are pointing to the best location to receive the strongest possible satellite signal.

The conventional technique in which an earth station antenna is calibrated to be positioned to receive the strongest satellite signal is by using a standard dithering technique. The earth station antenna moves one or two degrees in each angle and in each direction, using the dithering technique, to receive the satellite signal at each of these points. Then, the satellite signal strength in each of these locations is measured, and the direction where the strongest satellite signal is received is the direction in which the earth station antenna is pointed.

This approach seems viable, however it is not totally accurate. There is no guarantee that the satellite signal strength being transmitted from the satellite is constant during the entire dithering process. In addition, there is no guarantee that the sky conditions remain the same during that time. Clouds and various forms of precipitation can alter the measurements and accuracy of the satellite signal. Thus, the conventional technique of positioning an earth station antenna to receive the maximum amount of signal strength from a satellite is not totally accurate.

The inventors have identified certain drawbacks and inefficiencies in the above-described conventional method of re-calibrating an earth station antenna. The re-calibration is not always accurate, therefore, the earth station is not always receiving the strongest signal it may be able to receive.

### SUMMARY OF INVENTION

An embodiment of the present invention is directed to a method of using ephemeris data for positioning of an antenna of an earth station, the method includes the following steps: transmitting ephemeris data to the earth station, wherein the ephemeris data comprises positioning data of a satellite; receiving the ephemeris data to realize the location of the satellite; and adjusting the antenna of the earth station to point toward the satellite, using the received ephemeris data.

In one embodiment, the satellite is in a geo-synchronous orbit.

In another embodiment, the ephemeris data is transmitted to the earth station periodically.

In yet another embodiment, the ephemeris data is transmitted to the earth station continuously.

In another embodiment, the earth station is a receiver for receiving data transmitted from a corresponding satellite.

In one embodiment, the ephemeris data transmitted by the satellite is obtained and calculated using sensors located on the satellite.

In another embodiment, the ephemeris data transmitted by the satellite is obtained and calculated using data received by the satellite from a plurality of beacons located on the surface of the earth.

In yet another embodiment, the ephemeris data transmitted by the satellite is obtained and calculated using sensors on the satellite used to track distances and angles from celestial bodies.

Another embodiment of the present invention is directed to a method of using ephemeris data for positioning of an antenna of an earth station, the method includes the following steps: receiving, at the satellite, data from a plurality of beacons on a surface of earth or from celestial bodies in the sky; calculating the data received to calculate positioning of a satellite, wherein the calculated data corresponds to the ephemeris data; transmitting the ephemeris data from the satellite; receiving the ephemeris data at the earth station; and adjusting the antenna of the earth station to point toward the satellite, using the received ephemeris data.

Another embodiment of the present invention is directed to a method of using transmitted data for positioning of an antenna of an earth station, the method includes the following steps: receiving, at a satellite, data from a surface of earth, wherein the data comprises positioning status of the satellite; continuously transmitting the data comprising the positioning status of the satellite to the earth station; receiving the data comprising the positioning status of the satellite at the earth station; and adjusting the antenna of the earth station to point toward the satellite using the received data comprising the positioning status of the satellite.

Yet another embodiment of the present invention is directed to a method of using ephemeris data for positioning of an antenna of an earth station. The method includes the following steps: means for receiving, at a satellite, data from a plurality of beacons on a surface of earth or from celestial bodies in the sky; means for calculating the data received to calculate positioning of a satellite, wherein the calculated data corresponds to the ephemeris data; means for transmitting the ephemeris data along with other data from the satellite; means for receiving, at the earth station, the ephemeris data and the other data; means for extracting the ephemeris data from data received from the satellite; and means for adjusting the antenna of the earth station to point toward the satellite, using the ephemeris data.

Still another embodiment of the present invention is directed to a method of using transmitted data for positioning of an antenna of an earth station. The method includes the following steps: means for receiving, at a satellite, data from a surface of earth, wherein the data comprises positioning status of the satellite; means for transmitting the data comprising the positioning status of the satellite; means for receiving the data comprising the positioning status of the satellite at the earth station; and means for adjusting the antenna of the earth station to point toward the satellite using the received data comprising the positioning status of the satellite.

### BRIEF DESCRIPTION OF THE DRAWINGS

The accompanying drawings, which are incorporated in and constitute a part of the specification, illustrate a presently preferred embodiment of the invention, and, together with the general description given above and the detailed description of the preferred embodiment given below, serve to explain the principles of the invention.

FIG. 1 is a diagrammatic representation illustrating a satellite communication system of the present invention.

FIG. 2 is a flow chart illustrating method steps according to an embodiment of the present invention.

FIG. 3 is a flow chart illustrating method steps according to an embodiment of the present invention.

FIG. 4 is a flow chart illustrating method steps according to an embodiment of the present invention.

FIG. 5 is a block diagram illustrating system components used in a method of the present invention.

FIG. 6 is a block diagram illustrating a satellite used in an embodiment of the present invention.

FIG. 7 is a schematic illustration of the constellation of communications satellites that may be utilized in the present invention.

FIG. 8 is an example of a satellite ephemeris data transmission.

### DETAILED DESCRIPTION OF THE PREFERRED EMBODIMENTS

As described herein with reference to the accompanying drawings, the present invention provides a method and system for accurately positioning an earth station antenna.

To facilitate understanding of the present invention, the following definitions are provided:

Definitions

Satellite Ephemeris Data: Used to determined the position of a satellite, at successive future time periods. Used to calculate the satellite location by using the known terminal location, computing the local Time of Day, computing range, applying delay calibrations, and finally computing Doppler and delay.

Earth Station Antenna: An antenna that receives signals output from a satellite, and which is coupled to an earth station.

Beacon: A transmitter that transmits signals at a fixed frequency and usually at a fixed power.

Geo-synchronous Orbit: An orbit in which a satellite moves at the same speed as the earth's rotation; and where the orbit is approximately 22,236 miles above the earth's surface.

Geo-stationary Box: ephemeral limits wherein the satellite location is confined. The positioning of the satellite is usually controlled through an independent command radio link from the earth.

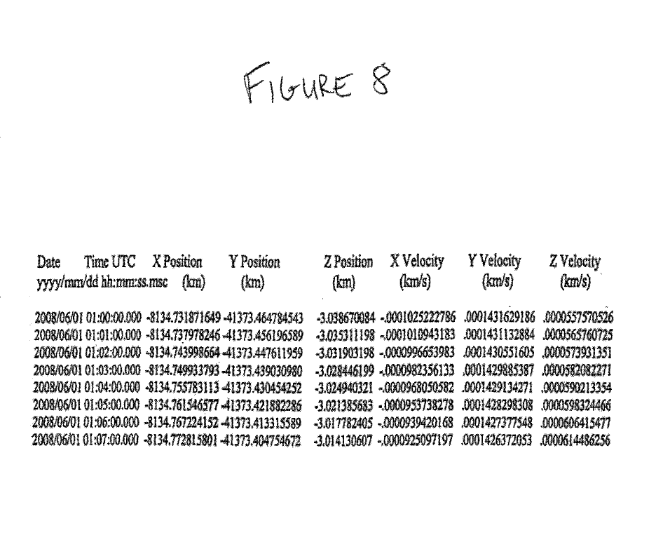

By way of example and not by way of limitation, ephemeris data comprises a six-element vector. Each element is 32-bits. The vector includes Xs, Ys and Zs, which denote the satellite range or position with an error of less than ±200 meters. It also comprises Vx, Vy, and Vz, which denote satellite range rate or velocity with an error of 0.1 meters/second. An example of the 6-element vector is shown in FIG. 8.

FIG. 8 is an example of an expected satellite ephemeris data transmission. The date and time are shown, as well as six elements in the vector comprising satellite position and velocity. The date is labeled with the year first, then the month and then the date. The time is labeled with the hour first, then the minutes, seconds and then the milliseconds. The position of the satellite is measured in kilometers and the velocity in kilometers per second. It is periodically or continuously transmitted from a satellite to an earth station and is used in the present invention to insure that the satellite remains within its geo-stationary box to allow an antenna of the earth station to be precisely pointed toward the satellite. Earth station antennas have a high gain and directivity, and they typically require continuous physical position adjustments to track the satellite within its geo-stationary box. The satellite moves within the box because of the elliptical shape of the orbit. Other causes of satellite movement within the box are mechanical problems at the satellite, for example. The satellite is able to stay within the geo-stationary box by various rockets or thrusters that are ignited at different times and locations on the satellite body to insure that it remains in control and within the geo-stationary box. If the earth station antenna fails to track the satellite with accuracy, the earth station antenna will not be able to receive signals output from the satellite.

The present invention provides for the use of satellite ephemeris data to point an earth station antenna. In the present invention, the ephemeris data is used to accurately point the earth station antenna directly to the satellite in orbit. Since this data is already being transmitted in certain existing satellites, the present invention requires little if any new costs or construction to those existing systems. In addition, there is negligible impact on satellite bandwidth and power resources.

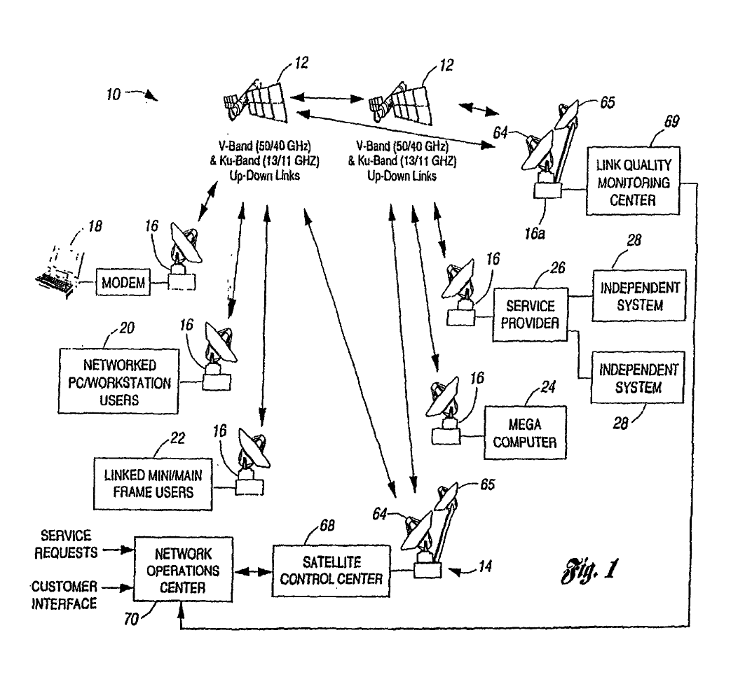

In reference to the figures, FIG. 1 is a diagrammatically illustrated representation of a satellite-based communications network 10 with a typical geometry for practicing the present invention. In general, the network 10 includes a plurality of communications satellites 12 in geo-synchronous orbit or medium earth orbit or low earth orbit, an earth station 14 for controlling and maintaining operation of each of the plurality of satellites 12, and a plurality of user terminals 16. The user terminals 16 may interconnect with a single computer 18, a group of networked PC/Workstation users 20, a group of linked mini/main frame users 22, a mega computer 24, or a service provider 26 that provides service to any number of independent systems 28.

The geo-synchronous satellites 12 are positioned in orbit locations supporting Fixed Satellite Service (FSS) coverage for domestic service and accommodating a primary range of frequencies and a secondary range of frequencies, such as 50/40 GHz V-band as well as 13/11 GHz Ku-band operation. The locations of satellites 12 accommodate emissions along with other co-orbiting satellites, and support service to and from high population metropolitan and business areas throughout the world. By way of example and not by way of limitation, the orbit locations include four satellites over the U.S., two each at 99° W and 103° W. To accommodate global growth and provide coverage to western Europe, central Europe, Middle East, and Africa, the orbit locations may further include eight other satellites, two each at 10° E and one at 63° W, 53° W, 48° E, 63.5° E, 115.4° E and 120.6° E. Each of the satellites 12 are high power satellites having 15-20 KW payload capability, such as an HS 702L High Power Spacecraft manufactured by Hughes Electronics Corporation, the assignee of the present invention. The HS 702L is a three-axis body-stabilized spacecraft that uses a five panel solar array system, along with outboard radiator panels attached to the main body to dissipate heat generated from the high powered Traveling Wave Tubes (TWTs).

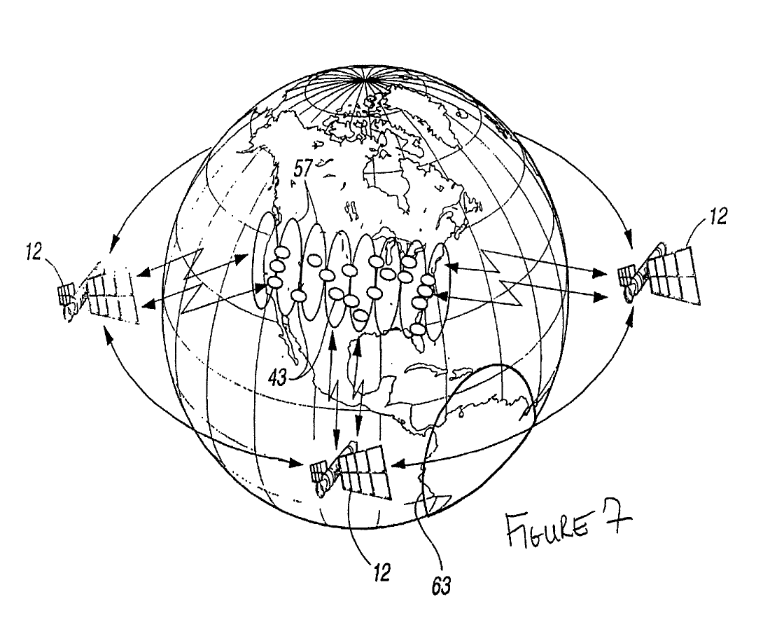

In the present invention, a surface, or area, to receive communications services of the present invention, is divided into a plurality of coverage areas 43, as shown in FIG. 7. Uplink and downlink antennas can support a predetermined number of coverage areas 43, e.g., 200. However, a subset of the plurality of coverage areas 43 is chosen to be used by uplink and downlink antennas to support communications services in predetermined metropolitan areas having heavy traffic. Any type of updated information is transmitted by earth station 14. Thus, usage of available satellite resources, such as weight and power, are utilized for only those beams that are selected and active.

Upon subscribing to the service provided by the network 10 of the present invention, a dedicated communications link is assigned to a user at a source location in one of the coverage areas 43 and a user at a destination location in another one of the coverage areas 43. This dedicated link is assigned an exclusive time channel in one of the frequency channels for transmitting and receiving communications signals.

As with primary communication payload, secondary communication payload includes an uplink antenna having a multi-beam array and a reflector, and a downlink antenna having a corresponding multi-beam array and reflector. Secondary communication coverage is preferably provided by two nadir-mounted dual-gridded reflector antennas, each illuminated by eight diplexed feeds for transmit and receive frequencies. Secondary communication antennas provide a total of eight dual polarized, elliptical area (3° ×1°) coverage beams 57, as shown in FIG. 7, for uplink and downlink services. Thus, secondary communication payload provides an eight-fold reuse of the spectrum for a total useable bandwidth of 4 GHz.

To provide for inter-hemisphere interconnectivity, inter-hemisphere link includes a single steerable horn, diplexed for transmit and receive frequencies providing one dual linearly polarized spot beam for uplink and downlink services. Horn transmits a 6° ×6°, 13/11 GHz area beam 63 towards the southern hemisphere, allowing thin route coverage of southern regions such as South America, as shown in FIG. 7. This beam may also provide north-south interconnection coverage to areas such as Europe and Africa.

Returning to FIG. 1, user terminals 16 include a primary antenna 64 for communicating with each of the satellites 12 in the primary range of frequencies, such as V-band frequencies. Thus, user terminals support data rates between 1.544 Mbps (equivalent to T1) and 155 Mbps (OC3 equivalent) via V-band antenna 64. Data rates below T1 are accommodated at user terminals 16 by sub-multiplexing the data to T1 (or higher) rates before transmission. Each of the user terminals 16 time-share the FDMA channels, with 100 TDMA channels in each 300 MHz FDMA channel. Since each TDMA channel supports a data rate of 1.544 Mbps, the network 10 provides a data throughput rate of 1.544 Gbps (100×1.544 Mbps×10) for each of the forty effective beams per satellite 12. For each FDMA channel, the channel data rate is 274.8 Mbps, which includes overhead for coding, transport protocol, network signaling, and access management. Uplink operation at each of the user terminals 16 operates in a burst mode at a data rate determined by the full FDMA channel plan.

Thirty watt high power amplifiers (HPA's) operate at saturation in the user terminals 16, with the user terminals 16 in each beam operating time shared on one of ten unique carrier frequencies. Out of band emissions are minimized in each user station 16. Each of the forty 3.0 GHz bandwidth beams is received and down converted, routed through circuit switch, upconverted, and amplified by a TWTA associated with a particular downlink beam. The downlink beams each have ten carriers, one for each FDMA channel. Each TWTA uses linearizers and operates with sufficient output backoff to ensure minimum out of band emissions and inter-modulation products.

User terminals 16a that cannot tolerate the expected loss of transmission due to weather outages further include a secondary communication antenna 65 for transmitting and receiving signals at the secondary range of frequencies. Secondary communication antenna 65 may or may not be the same as the primary communication antenna 64. User terminals 16a subscribing to this type of service include a link quality monitoring center 69 to monitor the quality of service of primary communication payload and routes it to a higher quality link, i.e., secondary communication payload, in the presence of adverse link propagation disturbance. The rerouting of traffic to a higher availability link is accomplished by communicating such conditions to an earth station 14.

The earth station 14 has two primary functions. Satellite control center 68 manages the health and status of all the satellites 12 and maintains their orbits. The network operations center 70 of earth station 14 provides resource management, fault management, accounting, billing, customer interfacing and service. Network operations center 70 of earth station 14 provides resource management, fault management, accounting, billing, customer interfacing, and service.

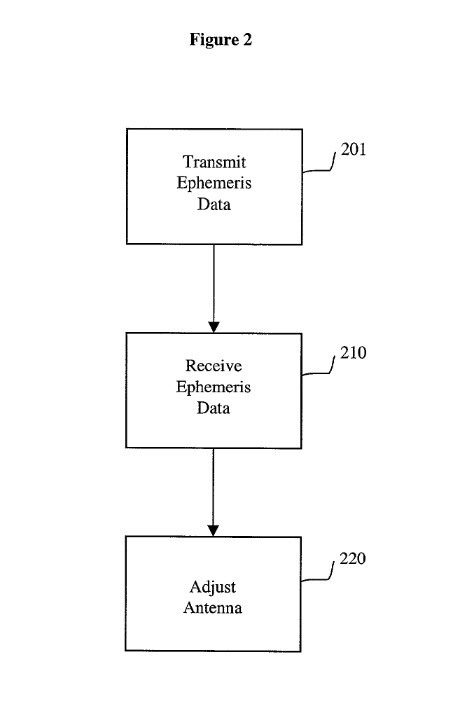

FIG. 2 is a flow chart illustrating method steps according to a preferred embodiment of the present invention. In step 201, a satellite transmits ephemeris data to an earth station. The transmitted ephemeris data can be obtained by the satellite in a number of methods. For example, one method of obtaining the data is by using sensors placed on the satellite. The sensors calculate the position of the satellite by tracking distances and angles from various stars. Based on the position of the satellite relative to these stars, information comprising the location of the satellite is generated. The information is sent down to the earth station antenna as the transmitted ephemeris data. Another method of obtaining ephemeris data is by placing beacons in various locations around the surface of the earth. The beacons transmit signals to the satellite from known locations on the earth. The positioning data is transmitted back to the earth station as ephemeris data.

In step 210, the earth station receives the ephemeris data informing the earth station of the present and future location of the satellite. In step 220, the earth station antenna is adjusted accordingly, to point directly toward the satellite using the received ephemeris data.

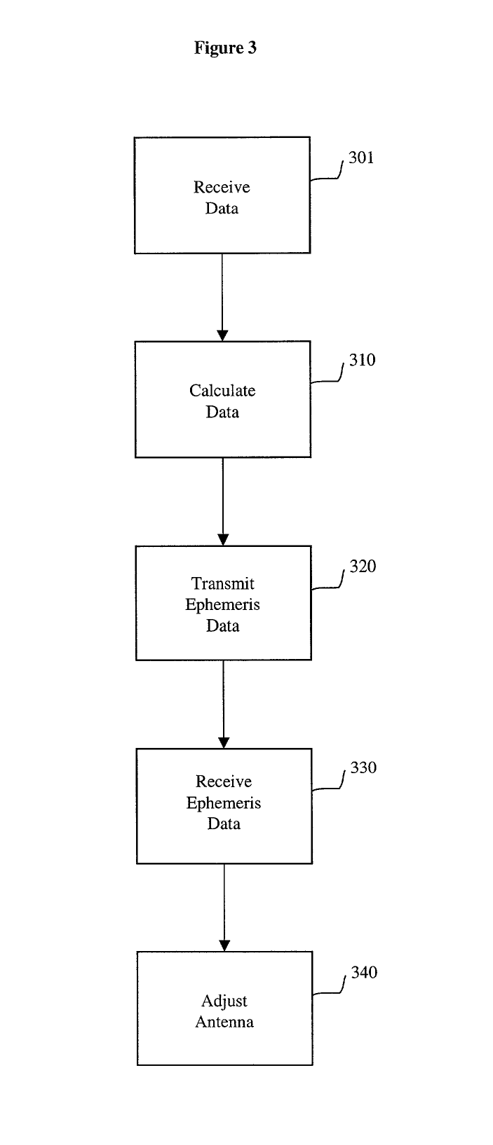

FIG. 3 is a flow chart illustrating another set of method steps according to a preferred embodiment of the present invention. In step 301, a satellite receives data from a variety of beacons that are placed on the surface of the earth. The data received by the satellite comprises information on the position of the satellite based on readings by the beacons. Upon receiving data from the beacons, in step 310, the satellite calculates the received data to determine the position of the satellite in the sky. In step 320, the satellite transmits the calculated positioning data, which is ephemeris data, to the earth station. In step 330, the earth station receives the ephemeris data. In step 340, the earth station antenna is adjusted to point toward the satellite, based on the transmission of ephemeris data that was obtained by the beacons on the surface of the earth.

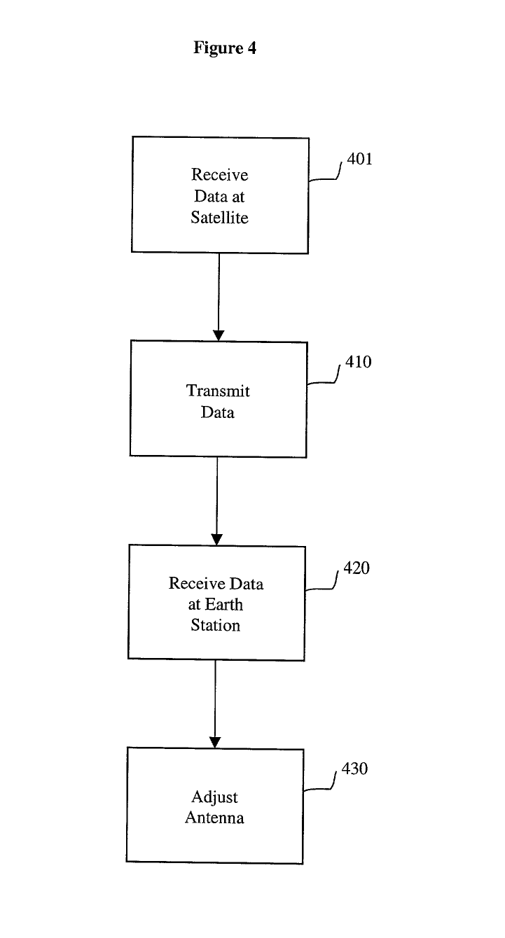

FIG. 4 is a flowchart illustrating yet another set of method steps according to a preferred embodiment of the present invention. In this embodiment of the present invention, in step 401, a satellite receives positioning data, used to compute ephemeris data, from the surface of the earth. This data comes from beacons placed on the surface of the earth. Alternatively, ephemeris data can be computed by sensors on the satellite picking up data from stars or from other celestial bodies in the sky. In step 410, the ephemeris data containing the position of the satellite is transmitted to an earth station. In step 420, the earth station continuously receives the ephemeris data. The earth station antenna is adjusted, in step 430, to point accurately toward the satellite. The adjustment is based on the positioning data that is transmitted and received between the satellite and the earth station. The ephemeris data that may be sent a few times a second, for example, is a frame of data within a stream of information output from the satellite to the earth station.

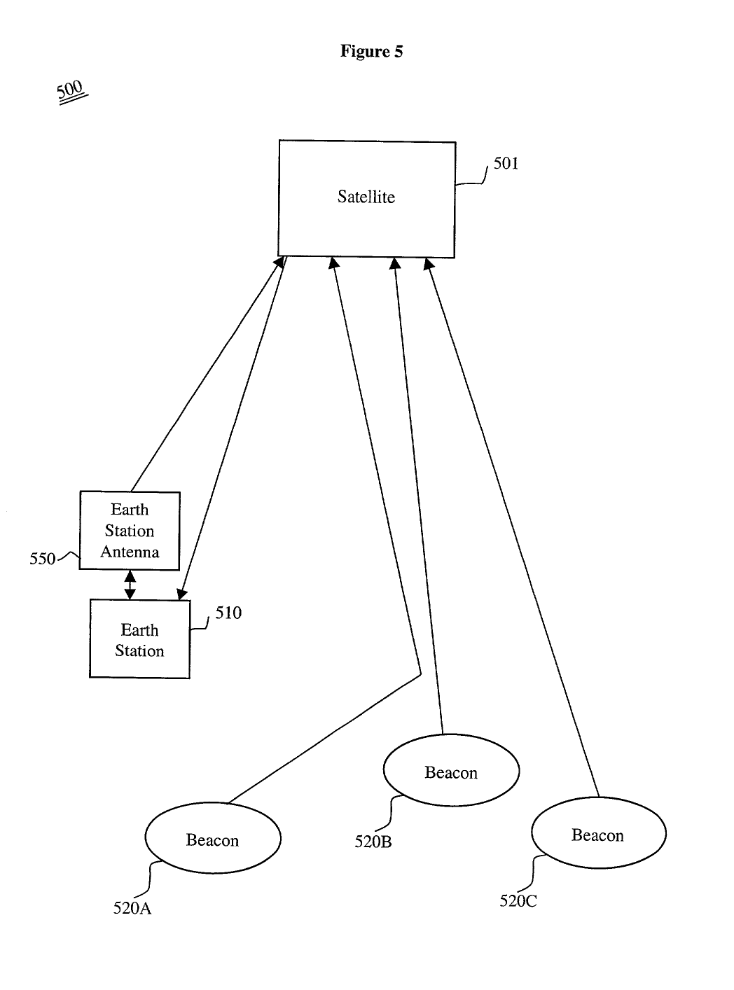

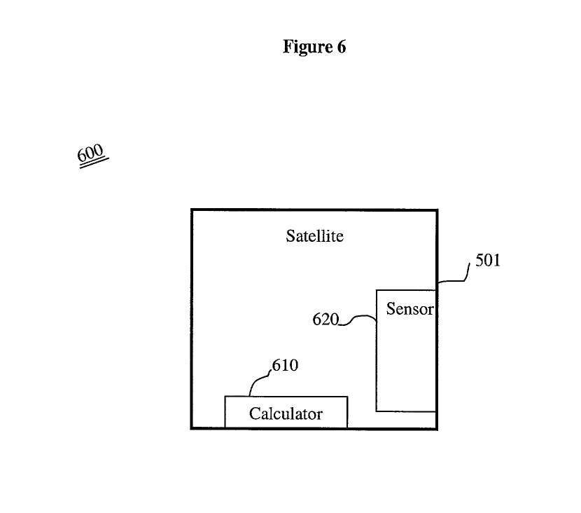

FIG. 5 is a block diagram illustrating the system components used in a preferred embodiment of the present invention. Beacons are placed on the surface of the earth. One embodiment of the present invention may include one beacon, other embodiments may include several beacons, and a further embodiment may include no beacons on the surface of the earth. In FIG. 5, there are three beacons shown, 520A, 520B and 520C. However, there may be other beacons on the surface of the earth that are not shown in FIG. 5. FIG. 5 serves only as an example of the system components, and does not limit the embodiments of the present invention. Beacons 520A, 520B and 520C each transmit a signal to the satellite 501, providing the satellite with information comprising its position in orbit. The satellite uses its Calculator 610, as shown in FIG. 6, to calculate its position using the information it receives from the Beacons 520A, 520B and 520C. The calculated information is transmitted to the Earth Station 510. The calculated information directs the Earth Station 510 to point the earth station antenna 550 in the direction where it receives the strongest signal from the Satellite 501.

Other embodiments of the present invention will be apparent to those skilled in the art from a consideration of the specification and the practice of the invention disclosed herein. It is intended that the specification be considered as exemplary only, with the true scope and spirit of the invention being indicated by the following claims.

What is claimed is:

1. A method of using ephemeris data for positioning of an antenna of an earth station, the method comprising the steps of:
transmitting ephemeris data to the earth station, wherein the ephemeris data comprises positioning data of a satellite;
receiving the ephemeris data to realize the location of the satellite; and
adjusting the antenna of the earth station to point toward the satellite, using the received ephemeris data.

2. The method according to claim 1, wherein the satellite is in a geo-synchronous orbit.

3. The method according to claim 1, wherein the ephemeris data is transmitted to the earth station periodically.

4. The method according to claim 1, wherein the ephemeris data is transmitted to the earth station continuously.

5. The method according to claim 1, wherein the earth station is a receiver for receiving data transmitted from a corresponding satellite.

6. The method according to claim 1, wherein the ephemeris data transmitted by the satellite is obtained and calculated using sensors located on the satellite.

7. The method according to claim 1, wherein the ephemeris data transmitted by the satellite is obtained and calculated using data received by the satellite from a plurality of beacons located on the surface of the earth.

8. The method according to claim 1, wherein the ephemeris data transmitted by the satellite is obtained and calculated using sensors on the satellite used to track distances and angles from celestial bodies.

9. A method of using ephemeris data for positioning of an antenna of an earth station, the method comprising the steps of:
receiving, at a satellite, data from a plurality of beacons on a surface of earth or from celestial bodies in the sky;
calculating the data received to calculate positioning of a satellite, wherein the calculated data corresponds to the ephemeris data;
transmitting the ephemeris data from the satellite;
receiving the ephemeris data at the earth station; and
adjusting the antenna of the earth station to point toward the satellite, using the received ephemeris data.

10. The method according to claim 9, wherein the satellite is in a geo-synchronous orbit.

11. The method according to claim 9, wherein the ephemeris data is transmitted to the earth station periodically.

12. The method according to claim 9, wherein the ephemeris data is transmitted to the earth station continuously.

13. The method according to claim 9, wherein the earth station is a receiver for any type of data transmitted from a corresponding satellite.

14. The method according to claim 9, wherein the plurality of beacons on the surface of the earth transmit information to the satellite, wherein the information comprises of positioning data for the satellite.

15. A method of using transmitted data for positioning of an antenna of an earth station, the method comprising the steps of:
receiving data, at a satellite, from a surface of earth, wherein the data comprises positioning status of the satellite;
continuously transmitting the data comprising the positioning status of the satellite to the earth station;
receiving the data comprising the positioning status of the satellite at the earth station; and
adjusting the antenna of the earth station to point toward the satellite using the received data comprising the positioning status of the satellite.

16. The method according to claim 15, wherein the satellite is in a geo-synchronous orbit.

17. The method according to claim 15, wherein the ephemeris data is transmitted to the earth station periodically.

18. The method according to claim 15, wherein the ephemeris data is transmitted to the earth station continuously.

19. The method according to claim 15, wherein the earth station is a receiver for data transmitted from a corresponding satellite.

20. A method of using ephemeris data for positioning of an antenna of an earth station, the method comprising the steps of:
means for receiving, at a satellite, data from various beacons on a surface of earth or from celestial bodies in the sky;
means for calculating the data received to calculate positioning of a satellite, wherein the calculated data corresponds to the ephemeris data;
means for transmitting the ephemeris data along with other data from the satellite;
means for receiving, at the earth station, the ephemeris data and the other data;
means for extracting the ephemeris data from data received from the satellite; and
means for adjusting the antenna of the earth station to point toward the satellite, using the ephemeris data.

21. The method according to claim 20, wherein the satellite is in a geo-synchronous orbit.

22. A method of using transmitted data for positioning of an antenna of an earth station, the method comprising the steps of:
means for receiving data from a surface of earth to a satellite, wherein the data comprises positioning status of the satellite;
means for transmitting the data comprising the positioning status of the satellite;
means for receiving the data comprising the positioning status of the satellite at the earth station; and
means for adjusting the antenna of the earth station to point accurately towards the satellite using the received data comprising the positioning status of the satellite.

23. The method according to claim 22, wherein the satellite is in a geo-synchronous orbit.
